(19) United States
(12) Patent Application Publication
(10) Pub. No.: US 2026/0020564 A1
(43) Pub. Date: Jan. 22, 2026

(54) FUNGAL DISEASES REDUCTION AND YIELD IMPROVEMENT METHODS AND COMPOSITION THEREOF

(71) Applicant: ELICIT PLANT, Moulins-sur-Tardoire (FR)

(72) Inventors: Justine Claverie, Moulins-sur-Tardoire (FR); Felipe Sulzbach, Alphaville (BR); Karol Czelusniak, Alphaville (BR); Aymeric Molin, Moulins-sur-Tardoire (FR)

(21) Appl. No.: 19/272,706

(22) Filed: Jul. 17, 2025

Related U.S. Application Data
(63) Continuation-in-part of application No. 18/778,041, filed on Jul. 19, 2024.

(51) Int. Cl. A01N 43/56; A01N 25/02; A01N 43/16; A01N 43/707; A01N 45/00; A01N 55/02; A01P 3/00; A01P 21/00

(52) U.S. Cl. CPC A01N 43/56; A01N 25/02; A01N 43/16; A01N 43/707; A01N 45/00; A01N 55/02; A01P 3/00; A01P 21/00

(57) ABSTRACT

The invention relates to a method of cultivating soybean exposed to at least one fungal disease comprising a step of applying to said cultivated soybean an effective treatment with a fungicide composition comprising at least fluxapyroxad in combination with at least two applications of a phytosterol composition comprising at least one phytosterol and at least one sucrose fatty acid ester to increase the yield of said cultivated soybean and/or to reduce the effects of said at least one fungal disease in comparison to soybeans under similar conditions treated only with the organo-chemical fungicide treatment.

### CROSS REFERENCE TO RELATED APPLICATIONS

This is a Continuation-in-Part Application of U.S. Ser. No. 18/778,041 filed Jul. 19, 2024, which is herein incorporated by reference in its entirety including, without limitation, the specification, claims, and abstract, as well as any figures, tables, or drawings thereof.

### FIELD OF THE INVENTION

The invention relates to the prevention or the resolution of adverse effect of various diseases that soybean (Glycine max) may be subjected during its lifecycle. Currently, such diseases are treated by successive applications of combinations of fungicides, but even with these combinations the harvest yield may not be guaranteed. Hence, the invention relates to a method of cultivating soybean exposed to at least one fungal disease, using a phytosterol composition mixed with one fungicide composition comprising at least one organo-chemical fungicide, thus increasing the harvest yield and/or controlling the said fungal disease.

### STATE OF THE ART

Soybean (Glycine max) is one of the most cultivated legumes worldwide, thanks to its numerous uses in human food and livestock feeding. Brazil notably has become the main producer since 2010, and Brazil together with the USA account for more than 60% of the cumulated production.

Despite its strategic necessity, soybean is highly sensitive to abiotic and/or biotic stresses. In particular, soybean plants may be subjected to a variety of diseases and pests. In descending order of criticality but not in an exhaustive fashion, harvest yields can be affected by the following fungal diseases, resulting from the fungal pathogen mentioned in parentheses:
Asian soybean rust (Phakopsora pachyrhizi),
Target spot (Corynespora cassiicola),
Powdery mildew (Erysiphe diffusa),
Anthracnose (Colletotrichum truncatum),
Purple seed stain and cercospora leaf blight (Cercospora kikuchii),
Brown spot (Septoria glycines), and/or
New World soybean rust (Phakopsora meibomiae).

Asian soybean rust (Phakopsora pachyrhizi) is of most concern as it is able to cause dramatic yield losses of soybean, which can impact up to the totality of the expected harvest. This disease is currently particularly active in the Americas, but infectious spots are also reported in many other countries around the world.

To fight against the above mentioned diseases, farmers may use several technical options, but it has become a necessity to spread fungicides, in particular organo-chemical fungicides, multiple times, both in protective and in curative ways. In other words, there is no current intensive soybean cultivation which does not use fungicides. These organo-chemical fungicides are usually combined because of the possibility to use different modes of action against the fungus:
DMI: Demethylation inhibitor, also known as Sterol biosynthesis inhibitor (SBI),
QₒI: quinone outside inhibitor,
SDHI: succinate dehydrogenase,
Multisite action.

These organo-chemical fungicides can also be sorted according to their main chemical structure: strobilurins, chloronitriles, carbamates and analogues (especially dithiocarbamates), and triazoles. Among these, strobilurins and triazoles are the most effective for managing soybean diseases and, sometimes, maintaining yield over diverse locations. They can be used solo but they work better when mixed, so as to fight against the fungus either at the sporulation stage (QₒIs) or at the growth stage (DMIs). However, when mixed and in the case of Asian soybean rust, the treatment may not be effective in controlling the disease and improving yields at the same time. In other words, the application of organo-chemical fungicides can control the severity of the disease without guaranteeing yields, i.e. yields similar to or even higher than those of a plant grown in the same soil and climate conditions but not exposed to the disease.

Controlling a disease is highly dependent to its nature and the phenological stage organo-chemical fungicides are applied onto soybean. Moreover, these recent years have seen a loss of fungicide efficiency due to acquired resistance of Asian soybean rust, even for the most efficient QₒI- or DMI-based treatments. Another issue related with organo-chemicalfungicides is their mode of action based on protection, which requires several and frequent applications so as to remain on the leaf surface.

Besides, it appears that controlling the severity of a disease does not necessarily mean that yields will be maintained or increased.

In this context, there is a need to find a treatment method which would allow both a mitigation of the disease and a preservation or an increase of the harvest yield, whether the treatment is applied preventively (i.e., before the emergence of the disease) or curatively. For instance, Asian soybean rust usually appears at blooming and/or end-of-cycle diseases appear at a late phenological stage.

### DISCLOSURE OF THE INVENTION

### Definitions

As used therein, the expressions “prophylactic treatment” and “preventive treatment” may be used interchangeably and mean a treatment which is intended to prevent a disease which has not yet appeared on soybean.

As used therein, the expressions “effective treatment” and “effective amount” refer to the quantities and dosages necessary to achieve the desired result, i.e. an increase of the yield of cultivated soybean and/or a reduction of the effects/the severity of fungal disease on said cultivated soybean in comparison to soybeans under similar conditions but treated only with the organo-chemical fungicide treatment.

As used therein, the expression “curative treatment” means a treatment which is intended to cure an already existing disease. In the context of the invention, this curative treatment is performed after blooming.

As used therein, the expressions “combined” or “in combination with” refer to an association of at least two compounds, the said two compounds being combined one prior to the other, the two concomitantly, or one after a step of another. In other words, these expressions encompass a sequence of application of the said at least 2 compounds, i.e. the first compound before the second compound, the first compound after the second compound or at least two compounds applied concomitantly, either in the form of a single product, i.e. a mixture of the at least 2 compounds, or in the form of two separated products being combined for the use. For example, this combination can be in the form of a premix or a kit.

As used therein, the expression “treated” soybean refers to cultivated soybean which is preventively or curatively treated with the method of the invention and which undergoes growth while being exposed to one or more diseases.

As used herein, the expression “untreated” soybean refers to cultivated soybean which is untreated with the method of the invention and which undergoes growth by being exposed to the same one or more diseases as the treated crops.

As used therein, “similar conditions” means substantially the same pedoclimatic conditions and other environmental factors various cultivated soybeans (e.g., untreated and treated soybeans) are exposed to.

As used therein, the expression “biotic stress” refers to a damage performed on cultivated soybean by living organisms, such as bacteria, viruses, fungi, parasites, insects and weeds.

As used therein, the expressions “prior to the onset of a biotic stress” and “prior to the exposure to a biotic stress”, may be used interchangeably and refer to the period during which soybean has not been attacked thus far by any living organism, i.e. before the first symptoms appear, for example before the first spots or degraded material appear on the leaves and/or stems of soybean.

As used therein, the phrase “severity of the fungal disease” refers to the average severity of the disease on all of the leaves of the cultivated soybean. The severity of the disease on one leaf is the surface area of the leaf that is covered by the disease and is expressed in percentage, relative to the total plant tissue that is considered in the measurement.

As used therein, the terms “efficiency” and “control” can be used interchangeably and refer to the capacity of a composition used in the method of the invention to mitigate the severity of a disease in cultivated soybean in comparison to cultivated soybean under similar conditions but not treated with such composition.

As used therein, “fungicide” refers to an organo-chemical fungicide, as opposite to microbial, inorganic or natural fungicides (vegetal or mineral oils).

As used therein, an “organo-chemical fungicide treatment sequence” refers to an iterative treatment of the cultivated soybean by organo-chemical fungicides at different stages of the plant's development, the organo-chemical fungicides used at each iteration being the same or different or in different combinations.

As used therein, the expressions “plant sterol” and “phytosterol” may be used indifferently and refer to any vegetally-occurring or chemically-synthesized sterol.

As used therein, the expression “sterol” refers to any vegetally-, animally-occurring, or chemically-synthesized sterol. The expression “sterol” therefore embraces the expression “plant sterol”.

As used therein, the expression “phytosterol composition” refers to a composition comprising at least one phytosterol and at least one sucrose fatty acid ester.

As used therein, cholesterol can be indifferently considered as a vegetally- or an animally-occurring sterol, since this sterol can be found both in some vegetals and in some animals.

As used herein, the terms “yield” or “harvest yield” refer to the amount of product harvested, more precisely the seed of harvested soybeans.

As used herein, the expression “sustain the yield” refers to a yield which is substantially unchanged from one to another situation, meaning that the deviation between the yield of one and the yield of another situation is more or less the same by 3% or less.

As used herein, the term “cultivated soybean,” in contrast to a naturally existing soybean, refers to soybean that can be cultivated, i.e., sown, planted, and exploited by man.

As used therein, the terms “crops” and “plants” may be used indifferently and refer to all plants and plant populations such as desirable and undesirable wild plants, cultivars, and plant varieties (whether or not protectable by plant variety or plant breeder's rights). Cultivars and plant varieties can be plants obtained by conventional propagation and breeding methods which can be assisted or supplemented by one or more biotechnological methods such as by use of double haploids, protoplast fusion, random and directed mutagenesis, molecular or genetic markers or by bioengineering and genetic engineering methods.

As used therein, the term “plant” includes whole plants and parts thereof, including, but not limited to, shoot vegetative organs/structures (e.g., leaves, stems and tubers), roots, flowers and floral organs/structures (e.g., bracts, sepals, petals, stamens, carpels, anthers and ovules), seeds (including embryo, endosperm, and seed coat) and fruits (the mature ovary), plant tissues (e.g., vascular tissue, ground tissue, and the like) and cells (e.g., guard cells, egg cells, and the like), and progeny of same. “Fruit” and “plant produce” are to be understood as any plant product which is further utilized after harvesting, e.g., fruits in the proper sense, nuts, wood etc., that is anything of economic value produced by the plant.

As used therein, the expression “physiological stage” refers to the extended BBCH-scale which is a system for a uniform coding of phenologically similar growth stages of all mono-and dicotyledonous plant species. The decimal code, which is divided into principal and secondary growth, the secondary growth being included in the principal growth (i.e., R5.5 is included in R5). These stages may include germination, vegetative growth, flowering, fruiting, and fruit ripening.

As used therein, the term “slurry” refers to the composition of the invention diluted in water or in a solution containing water and, optionally one or more other active ingredients.

As used therein, the term “tank-mix” means that active ingredients are mixed in the water tank to form the slurry, which is then being sprayed on the plants.

As used herein, “biocontrol product” is defined as an agent or product that uses natural mechanisms. They form a set of tools that can be used, alone or in combination with other plant protection methods, to combat crop enemies in integrated pest management.

As used therein, “Dikarya” is a subkingdom of Fungi that includes the divisions Ascomycota and Basidiomycota.

As used therein, the expression “foliar spray” refers to a pressurized projection of a slurry that forms numerous microdroplets that cover the upper and/or lower surfaces of the treated leaf.

The use of “a” or “an” for a molecule does not exclude, unless otherwise stated, the presence of plurality of molecules, in such a way that the expression “one or more” can be substituted for it.

As used therein, the expression “insoluble in the aqueous phase” refers to a compound which presents the inability to form with water a homogenous, one-phase solution at the microscopic or the macroscopic level, at a given temperature and atmospheric pressure.

By contrast and as used therein, the term “solubility” refers to a compound which leads to a homogenous solution without remaining insoluble particles when it is added to a liquid, at a given temperature and atmospheric pressure.

Any percentage by weight of a molecule comprised in the composition used in the method of the invention refers to the total weight of the said composition, which means relative to the sum of all ingredients giving a hundred. Weight percent can be symbolized as wt %.

Various aspects of the invention can be presented in a range format. The description in range format is merely for convenience and conciseness and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### DETAILED DESCRIPTION OF THE INVENTION

It is an object of the present invention to provide a method of cultivating soybean exposed to at least one fungal disease comprising a step of applying to said cultivated soybean a combination comprising:
(i) an effective amount of at least one fungicide composition comprising at least one organo-chemical fungicide, and
(ii) an effective amount of at least one phytosterol composition comprising at least one phytosterol and at least one sucrose fatty acid ester,
   wherein at least two applications of said at least one phytosterol composition are combined with at least two applications of said at least one fungicide composition.

In a specific embodiment, at least one organo-chemical fungicide comprises an effective amount of fluxapyroxad.

It is an object of the present invention to provide a method of cultivating soybean exposed to at least one fungal disease comprising a step of applying to said cultivated soybean an effective treatment with a fungicide composition comprising at least one organo-chemical fungicide in combination with a phytosterol composition comprising at least one phytosterol and at least one sucrose fatty acid ester, wherein at least two applications of said phytosterol composition are combined with at least two applications of said treatment with said fungicide composition comprising at least one organo-chemical fungicide, and wherein the treatment with said combination increases the yield of said cultivated soybean in comparison to soybeans under similar conditions but treated only with the organo-chemical fungicide.

It is also another object of the invention to provide a method of controlling at least a fungal disease of cultivated soybean comprising a step of applying to said cultivated soybean an effective treatment with a fungicide composition comprising at least one organo-chemical fungicide in combination with a phytosterol composition comprising at least one phytosterol and at least one sucrose fatty acid ester, wherein at least two applications of said phytosterol composition are combined with at least two applications of said treatment with said fungicide composition comprising at least one organo-chemical fungicide, and wherein the treatment with said combination reduced the effects of said at least one fungal disease on said field of cultivated soybean in comparison to soybeans under similar conditions only but treated with the organo-chemical fungicide.

It is also another object of the invention to provide a method of controlling at least a fungal disease of cultivated soybean comprising a step of applying to said cultivated soybean an effective treatment with a fungicide composition comprising at least one organo-chemical fungicide in combination with a phytosterol composition comprising at least one phytosterol and at least one sucrose fatty acid ester, wherein at least two applications of said phytosterol composition are combined with at least two applications of said treatment with said fungicide composition comprising at least one organo-chemical fungicide, and wherein the treatment with said combination sustains the yield of said cultivated soybean in comparison to soybeans under similar conditions but treated with a reduced dose of the fungicide composition comprising at least one organo-chemical fungicide, wherein the organo-chemical fungicide dose reduction is at least 10%, preferably 10% and 30%, more preferably 10 to 50% from recommended dosage.

The Applicant has thus ascertained that, most surprisingly, the harvest yield and/or the disease control of cultivated soybean could be improved with a method comprising a step of incorporating at least two applications to the said soybean of a composition comprising at least one phytosterol and at least one sucrose fatty acid ester into an organo-chemical fungicide treatment sequence.

It was observed that the phytosterol composition used in the method of the invention, when combined with a fungicide composition comprising at least one organo-chemical fungicide, reduced the severity of soybean diseases when it was applied prior to the onset of such diseases, that is to say before their emergence, which usually happen during or after the flowering stage of soybean, depending on the disease.

It was also observed that the phytosterol composition used in the method of the invention, when combined with a fungicide composition comprising at least one organo-chemical fungicide controlled the severity of soybean diseases when it was applied after the emergence of such diseases, thereby limiting the intensity of the disease, thus its potential damage on soybean.

According to the method of the invention, this control of the soybean disease is one of the ways to improve the harvest yield of cultivated soybean.

According to an embodiment, the two applications of said treatment with said fungicide composition comprising at least one organo-chemical fungicide correspond to two applications of same or different said fungicide composition for each application.

The phytosterol composition in combination with a fungicide composition comprising at least one organo-chemical fungicide can be applied to the cultivated soybean at least twice. It was observed that a single application of the phytosterol composition (i.e., without being combined with any organo-chemical fungicide) cannot afford a sufficient control of the soybean diseases to afford a suitable protection, and/or a sufficient increase of the yield. It was also observed that combining the at least one organo-chemical fungicide in combination with a phytosterol composition and applying them only once allows a slight increase only of the harvest yield and/or of the control of the at least one fungal disease. This is why the invention relies on at least two applications of said phytosterol composition combined with at least two applications of said treatment with a fungicide composition comprising at least one organo-chemical fungicide to effectively/significantly increase the harvest yield and the protection against at least one fungal disease.

A first possibility is to apply one of the two applications of the combination of a fungicide composition comprising at least one organo-chemical fungicide with a phytosterol composition comprising at least one phytosterol and at least one sucrose fatty acid ester before the onset of the disease, for example before blooming, for example one application at physiological stage V4 and one application at or after physiological stage R1, according to the Growth stages American literature. Irrelevant from the number of applications, the said at least two applications of a phytosterol composition comprising at least one phytosterol and at least one sucrose fatty acid ester is applied between physiological stage V3 and R6, in particular V3 and R5.6, more preferably between physiological stage R1 and R3.

According to the method of the invention, said at least two applications of said phytosterol composition comprising at least one phytosterol and at least one sucrose fatty acid ester is applied prior to, concomitantly, or after the application of the fungicide composition comprising at least one organo-chemical fungicide.

The combination of a fungicide composition comprising at least one organo-chemical fungicide with a phytosterol composition comprising at least one phytosterol and at least one sucrose fatty acid ester is particularly suitable for the prophylactic and/or the curative treatment of any fungal disease whose origin is related to the Dikarya sub-kingdom, more advantageously, to the division Basidiomycota or Ascomycota, preferably from the class selected from Pucciniomycetes, Sordariomycetes, Dothideomycetes or Leotiomycetes. It is particularly effective against Asian soybean rust, New world soybean rust, anthracnose, target spot, powdery mildew, cercospora leaf blight and end-cycle diseases such as purple seed stain and brown spot, and combination thereof, advantageously Asian soybean rust.

Asian soybean rust is caused by a biotrophic pathogen, i.e. the fungus Phakopsora pachyrhizi; cercospora leaf blight is caused by the fungus Cercospora kikuchii and/or Cercospora flagellaris; purple seed stain (also known as purple blotch, purple speck, purple spot or lavender spot) is caused by the fungus Cercospora kikuchii; anthracnose is caused by several species of Colletotrichum fungi including the fungus Colletotrichum truncatum; target spot is caused by the fungus Corynespora cassiicola; powdery mildew is caused by the fungus Microsphaera diffusa, also known as Erysiphe diffusa; brown spot (also known by the name Septoria Brown Spot) is caused by the fungus Septoria glycines; New World soybean rust is caused by the fungus Phakopsora meibomiae.

The phytosterol composition can be applied in combination with a fungicide composition comprising at least one or more organo-chemical fungicides.

The Applicant has assumed that the plant response, notably generated by phytosterol foliar application, against soybean diseases is systemic, that is to say the phytosterols have to penetrate soybean tissues to make the plant become more resilient to the detrimental effects of the said diseases. To reach this, at least one sucrose fatty acid ester is added to the phytosterol composition to improve the foliar uptake of the said at least one phytosterol. Thus, the phytosterol composition comprises at least one phytosterol and at least one sucrose fatty acid ester.

So far, more than 250 different phytosterols have been identified. The at least one phytosterol can be selected among the group of:
plant sterols: beta-sitosterol, campesterol, brassicasterol, stigmasterol, lanosterol, stigmastanol, campestanol, cycloartenol, gamma-sitosterol, Δ⁵-avenasterol, Δ⁷-avenasterol, isofucosterol, 5-dehydroepisterol, chlerosterol, beta-sitostanol, stigmastadioenol, isomers and derivatives thereof;
zoosterols: cholesterol, lathosterol, cholestanol, dinosterol, and derivatives thereof;
mycosterols: ergosterol, obtusifoliol, and derivatives thereof.

Preferably, the at least one phytosterol is chosen among the group of: beta-sitosterol, campesterol, brassicasterol, stigmasterol and/or cholesterol. Advantageously, the at least one phytosterol is beta-sitosterol and represents at least 30% of the phytosterols mixture by weight, with the balance to 100% preferably containing, where appropriate, campesterol, stigmasterol, cholesterol and brassicasterol.

According to a specific embodiment, the at least one phytosterol represents between 0.2% and 10% by weight of the total composition, advantageously between 0.5% and 7%, and preferably between 1% and 5%.

The at least one sucrose fatty acid ester is selected from the group consisting of saccharose stearate, saccharose palmitate, their polyesters, and mixtures thereof.

The concentration of the at least one sucrose fatty acid ester represents between 0.2% and 10% by weight of the total composition, advantageously between 3% and 7%.

According to a specific embodiment, the weight ratio of the at least one phytosterol to the at least one sucrose fatty acid ester is between 0.01 and 10, advantageously between 0.1 and 5, more advantageously between 0.2 and 1.5.

The phytosterol composition of the invention can take the form of a homogenous or heterogenous aqueous solution, an emulsifiable concentrate, a concentrated suspension, an oil-in-water or a water-in-oil emulsion, an oil-in-water or a water-in-oil suspo-emulsion, an oil dispersion and/or any other formulation the skilled artisan may find suitable for the invention purpose. Preferably, the phytosterol composition of the invention is an aqueous solution, an emulsion or a suspo-emulsion.

According to a specific embodiment, the phytosterol composition is a suspo-emulsion, which comprises at least one phytosterol and at least one sucrose fatty acid ester selected from the group consisting of sucrose stearate, saccharose palmitate and their polyesters, or mixtures thereof, acting either as surfactant participating to stabilize the oil-in-water emulsion, and as a free surfactant which is added to the water phase of the oil-in-water emulsion as a suspension. In one embodiment, the surfactant stabilizing the oil-in-water emulsion and the surfactant acting as a free surfactant are identical, e.g. sucrose stearate for both. In another embodiment, the surfactant acting in the oil-in-water emulsion and the surfactant acting as a free surfactant are different, e.g. sucrose stearate stabilizing the oil-in-water emulsion and saccharose palmitate as a free surfactant.

In another aspect of the invention, the skilled artisan may add to the phytosterol composition used in the method of the invention further molecules which would improve the efficiency of the said composition to treat soybean diseases and/or to improve the stability of the said phytosterol composition, that is to say at least one fluidifying agent, at least one solubilizing agent for phytosterols (also called fatty substance), at least one wetting agent, at least one preservative and/or at least one antioxidant.

According to a specific embodiment, the mixture of at least one phytosterol and the at least one sucrose fatty acid ester comprised in the composition used in the method of the invention is combined with at least one active ingredient. For the purposes of the invention, the term “active ingredient” refers to a product that helps the plant to fight against soybean diseases and/or to grow, advantageously selected from the group comprising:
a phytopharmaceutical product such as a plant growth regulator, a fungistatic agent, a bactericide, a bacteriostatic agent, an insecticide, an acaricide, a parasiticide, a nematicide, a mole toxicant, a molluscicide or a herbicide;
a biocontrol product based on natural mechanisms that enables plants to combat fungal infections, bacterial infections, viral infections, pest attacks and/or competition with weeds; and/or
a nutrient, organic or inorganic such as a micronutrient or a fertilizer.

More preferentially, the composition of the invention can be combined with at least one fungicide, in particular an organo-chemical fungicide and/or at least one nutrient.

According to a specific embodiment of the invention, the phytosterol composition can be applied in combination with a fungicide composition comprising at least one or more other organo-chemical fungicides and optionally at least one nutrient.

According to the invention, organo-chemical fungicides may be selected among the group consisting of:
1. Respiration inhibitors
a. Inhibitors of complex III at Qₒ site (e.g., strobilurins): azoxystrobin, coumethoxystrobin, coumoxystrobin, dimoxystrobin, enestroburin, famoxadone, fenamidone, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyraoxystrobin, trifloxystrobin, pyribencarb, triclopyricarb/chlorodincarb;
b. inhibitors of complex III at Qi site: cyazofamid, amisulbrom;
c. inhibitors of complex II (e.g. carboxamides): benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, benzovindiflupyr, inpyrfluxam, isofetamid, pydiflumetofen, fluindapyr;
d. complex I, uncouplers: diflumetorim;
e. nitrophenyl derivates: binapacryl, dinobuton, dinocap, fluazinam, ferimzone;
f. organometallic compounds: fentin acetate, fentin chloride, fentin hydroxide;
g. ametoctradin, silthiofam;
2. Sterol biosynthesis inhibitors (SBI fungicides)
a. C14 demethylase inhibitors (DMI fungicides):
i. triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, mefentrifluxonazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole;
ii. imidazoles: imazalil, pefurazoate, prochloraz, triflumizol;
iii. pyrimidines, pyridines and piperazines: fenarimol, nuarimol, pyrifenox, triforine;
b. Delta 14-reductase inhibitors: aldimorph, dodemorph, dodemorph-acetate, fenpropimorph, tridemorph, fenpropidin, piperalin, spiroxamine;
c. inhibitors of 3-keto reductase: fenhexamid;
3. Nucleic acid synthesis inhibitors
a. phenylamides or acyl amino acid fungicides: benalaxyl, benalaxyl-M, kiral-axyl, metalaxyl, ofurace, oxadixyl;
b. others: hymexazole, octhilinone, oxolinic acid, bupirimate, 5-fluorocytosine;
4. Inhibitors of cell division and cytoskeleton
a. tubulin inhibitors: benzimidazoles, thiophanates: benomyl, carbendazim, fuberidazole, thiabendazole, thiophanate-methyl, triazolopyrimidines;
b. cell division inhibitors: diethofencarb, ethaboxam, pencycuron, fluopicolide, zoxamide, metrafenone, pyriofenone;
5. Inhibitors of amino acid and protein synthesis
a. methionine synthesis inhibitors (anilino-pyrimidines): cyprodinil, mepanipyrim, pyrimethanil;
b. protein synthesis inhibitors: blasticidin-S, kasugamycin, kasugamycin hydrochloride-hydrate, mildiomycin, streptomycin, oxytetracyclin, polyoxine, validamycin A;
6. Signal transduction inhibitors
a. MAP/histidine kinase inhibitors: fluoroimid, iprodione, procymidone, vinclozolin, fenpiclonil, fludioxonil;
b. G protein inhibitors: quinoxyfen;
7. Lipid and membrane synthesis inhibitors
a. phospholipid biosynthesis inhibitors: edifenphos, iprobenfos, pyrazophos, isoprothiolane;
b. lipid peroxidation: dicloran, quintozene, tecnazene, tolclofos-methyl, biphenyl, chloroneb, etridiazole;
c. phospholipid biosynthesis and cell wall deposition: dimethomorph, flumorph, mandipropamid, pyrimorph, benthiavalicarb, iprovalicarb, valifenalate;
d. compounds affecting cell membrane permeability and fatty acids: propamocarb, propamocarb-hydrochloride fatty acid amide;
8. Inhibitors with Multi Site Action
a. thio-and dithiocarbamates: ferbam, mancozeb, maneb, metam, metiram, propineb, thiram, zineb, ziram;
b. chlorinated organic compounds (e.g. phthalimides, sulfamides, chloronitriles): anilazine, chlorothalonil, captafol, captan, folpet, dichlofluanid, dichlorophen, hexachlorobenzene, pentachlorophenol and its salts, phthalide, tolylfluanid, and others: guanidine, dodine, dodine free base, guazatine, guazatine-acetate, iminoctadine, iminoctadine-triacetate, iminoctadinetris (albesilate), dithianon;
9. Cell wall synthesis inhibitors
a. inhibitors of glucan synthesis: validamycin, polyoxin B;
b. melanin synthesis inhibitors: pyroquilon, tricyclazole, carpropamid, dicyclomet, fenoxanil;
10. Plant defense inducers
a. acibenzolar-S-methyl, probenazole, isotianil, tiadinil, prohexadione-calcium;
b. phosphonates: fosetyl, fosetyl-aluminum;
11. Unknown mode of action: bronopol, chinomethionat, cyflufenamid, cymoxanil, dazomet, debacarb, diclomezine, difenzoquat, difenzoquat methylsulfate, diphenylamin, fenpyrazamine, flumetover, flusulfamide, flutianil, methasulfocarb, nitrapyrin, nitrothal-isopropyl, oxine-copper, picarbutrazox, proquinazid, tebufloquin, tecloftalam, triazoxide.

In a preferred embodiment, the at least one organo-chemical fungicide is selected in the following table:

| | | | |
|---|---|---|---|
| | | | Recommended |
| | | | dose range per |
| Active ingredient | | CAS | application |
| name | Full chemical name | number | (g/ha) |

Strobilurins - QoI

| | | | |
|---|---|---|---|
| Azoxystrobin | methyl (2E)-2-(2-{[6-(2- | [131860- | 50-90 |
| | cyanophenoxy)pyrimidin-4- | 33-8] | |
| | yl]oxy}phenyl)-3-methoxyprop-2- | | |
| | enoate | | |
| Pyraclostrobin | methyl N-[2-[[1-(4- | [175013- | 80-150 |
| | chlorophenyl)pyrazol-3- | 18-0] | |
| | yl]oxymethyl]phenyl]-N- | | |
| | methoxycarbamate | | |
| Trifloxystrobin | methyl (2E)-2-methoxyimino-2-[2- | [141517- | 60-80 |
| | [[(E)-1-[3-(trifluoromethyl)phenyl]- | 21-7] | |
| | ethylideneamino]oxymethyl]phenyl]acetate | | |

Pyrazole-carboxamides - SDHI

| | | | |
|---|---|---|---|
| Benzovindiflupyr | N-[9-(dichloromethylene)-1,2,3,4- | [1072957- | 20-40 |
| | tetrahydro-1,4-methanonaphthalen-5- | 71-1] | |
| | yl]-3-(difluoromethyl)-1-methyl-1H- | | |
| | pyrazole-4-carboxamide | | |
| Bixafen | N-[2-(3,4-dichlorophenyl)-4- | [581809- | 55-100 |
| | fluorophenyl]-3-(difluoromethyl)-1- | 46-3] | |
| | methylpyrazole-4-carboxamide | | |
| Fluxapyroxad | 3-(difluoromethyl)-1-methyl-N- | [907204- | 40-75 |
| | (3′,4′,5′-trifluoro[1,1′-biphenyl]-2-yl)- | 31-3] | |
| | 1H-pyrazole-4-carboxamide | | |
| Fluindapyr | 3-(difluoromethyl)-N-(7-fluoro-1,1,3- | [1383809- | 50-75 |
| | trimethyl-2,3-dihydroinden-4-yl)-1- | 87-7] | |
| | methylpyrazole-4-carboxamide | | |
| Inpyrfluxam | 3-(difluoromethyl)-N-((3R)-2,3- | [1352994- | 30-50 |
| | dihydro-1,1,3-trimethyl-1H-inden-4- | 67-2] | |
| | yl)-1-methyl-1H-pyrazole-4- | | |
| | carboxamide | | |
| Pydiflumetofen | 3-(difluoromethyl)-N-methoxy-1- | [1228284- | 30-65 |
| | methyl-N-[1-(2,4,6-trichlorophenyl)-2- | 64-7] | |
| | propanyl]-1H-pyrazole-4-carboxamide | | |

Conazoles - SBI

| | | | |
|---|---|---|---|
| Cyproconazole | 2-(4-chlorophenyl)-3-cyclopropyl-1- | [94361- | 25-80 |
| | (1,2,4-triazol-1-yl)butan-2-ol) | 06-5] | |
| Difenoconazole | 1-[[2-[2-chloro-4-(4- | [119446- | 25-130 |
| | chlorophenoxy)phenyl]-4-methyl-1,3- | 68-3] | |
| | dioxolan-2-yl]methyl]-1,2,4-triazole | | |
| Mefentrifluconazole | 2-[4-(4-chlorophenoxy)-2- | [1417782- | 65-115 |
| | (trifluoromethyl)phenyl]-1-(1,2,4- | 03-6] | |
| | triazol-1-yl)propan-2-ol | | |
| Prothioconazole | 2-[2-(1-chlorocyclopropyl)-3-(2- | [178928- | 50-90 |
| | chlorophenyl)-2-hydroxypropyl]-1H- | 70-6] | |
| | 1,2,4-triazole-3-thione | | |

Aromatic and dithiocarbamate - Multisite

| | | | |
|---|---|---|---|
| Chlorothalonil | 2,4,5,6-tetrachlorobenzene-1,3- | [1897- | 460-1500 |
| | dicarbonitrile | 45-6] | |
| Mancozeb | manganese ethylenebis- | [8018- | 800-2250 |
| | dithiocarbamate (polymeric) complex | 01-7] | |
| | with zinc salt | | |

Advantageously, the fungicide composition comprises at least one organo-chemical fungicide which is selected in the group consisting of: bixafen, fluxapyroxad, benzovindiflupyr, fluindapyr, inpyrfluxam, chlorothalonil and their mixtures.

An aspect of the invention is to provide a method wherein the phytosterol composition is mixed with the fungicide composition comprising at least one organo-chemical fungicide.

According to the method of the invention, the effective treatment with a fungicide composition comprising at least one organo-chemical fungicide is a standard treatment with respect to regime and dosage as recommended for the treatment of soybean.

According to a specific embodiment, the effective treatment with a fungicide composition comprising at least one organo-chemical fungicide comprises between 50% and 100% of the organo-chemical fungicide amount applied in a recommended treatment, preferably between 70% and 100%, even more preferably between 90% and 100% of the organo-chemical fungicide amount applied in a recommended treatment, without decreasing the harvest yield.

According to a specific embodiment, the phytosterol composition used in the method of the invention is combined, advantageously mixed, with strobilurins, carboxamides, triazoles and/or chloronitriles.

In a most preferred embodiment, the phytosterol composition used in the method of the invention is combined, advantageously mixed, with strobilurins, pyrazole-carboxamides, conazoles, chlorothalonil, dithiocarbamates, and combination thereof.

Advantageously, the phytosterol composition used in the method of the invention is combined with bixafen, fluxapyroxad, benzovindiflupyr, fluindapyr, Inpyrfluxam or their mixtures.

According to the invention, nutrients is selected in the group consisting of nitrogen (N), phosphorus (P), potassium (K), sulfur (S), calcium (Ca), magnesium (Mg), copper (Cu), iron (Fe), manganese (Mn), zinc (Zn), boron (B), chloride (Cl), cobalt (Co), molybdenum (Mo), nickel (Ni) and their mixtures.

According to a specific embodiment, the phytosterol composition used in the method of the invention is combined, advantageously mixed, with nitrogen, molybdenum and boron.

According to another specific embodiment, the phytosterol composition used in the method of the invention is combined, advantageously mixed, with cobalt, molybdenum and boron.

According to another specific embodiment, the phytosterol composition used in the method of the invention is combined, advantageously mixed, with nitrogen and boron.

According to another specific embodiment, the phytosterol composition used in the method of the invention is combined, advantageously mixed, with molybdenum and boron.

Another aspect of the invention is to provide a method to treat in a prophylactic way and/or in a curative way soybean against soybean diseases, by at least two applications of the phytosterol composition above described, preferably between two and four applications.

In one embodiment, the method consists in applying to the soybean plant a foliar spray of a dilution of the fungicide composition comprising at least one organo-chemical fungicide in combination with a phytosterol composition comprising at least one phytosterol and at least one sucrose fatty acid ester, prior to or after the onset of the disease. Irrelevant from the number of applications, this treatment with said combination is performed at a total concentration of said at least one phytosterol between 2.5 g/ha to 250 g/ha, preferably between 12.5 and 125 g/ha, more preferably between 25 g/ha and 100 g/ha, the said concentration being expressed in grams per hectare of phytosterol.

In another embodiment, the at least two applications of said phytosterol composition are combined with at least two applications of a treatment with said fungicide composition comprising at least one organo-chemical fungicide. Combined means that each of said application of said phytosterol composition may occur prior to, concomitantly or after the step of each said application of said treatment with at least one organo-chemical fungicide.

For example,
the first application of the phytosterol composition is applied concomitantly with the first application of the fungicide composition comprising at least one organo-chemical fungicide, the second application of the phytosterol composition is applied concomitantly with the second application of the fungicide composition comprising at least one organo-chemical fungicide; or
the first application of the phytosterol composition is applied before the first application of the fungicide composition comprising at least one organo-chemical fungicide, the second application of the phytosterol composition is applied concomitantly with the second application of the fungicide composition comprising at least one organo-chemical fungicide; or
the first application of the phytosterol composition is applied after the first application of the fungicide composition comprising at least one organo-chemical fungicide, the second application of the phytosterol composition is applied concomitantly with the second application of the fungicide composition comprising at least one organo-chemical fungicide; or
the first application of the phytosterol composition is applied concomitantly with the first application of the fungicide composition comprising at least one organo-chemical fungicide, the second application of the phytosterol composition is applied before the second application of the fungicide composition comprising at least one organo-chemical fungicide; or
the first application of the phytosterol composition is applied concomitantly with the first application of the fungicide composition comprising at least one organo-chemical fungicide, the second application of the phytosterol composition is applied after the second application of the fungicide composition comprising at least one organo-chemical fungicide.

According to a first specific embodiment related to the use of fluxapyroxad, the method comprises at least two applications of at least one organo-chemical fungicide, one application only being an organo-chemical fungicide comprising fluxapyroxad.

Advantageously, the organo-chemical fungicide comprising an effective amount of fluxapyroxad and the at least one phytosterol composition are applied concomitantly.

In that specific embodiment, at least one phytosterol composition is advantageously applied prior to the application of the organo-chemical fungicide comprising an effective amount of fluxapyroxad and at least one phytosterol composition. Both phytosterol compositions are preferably identical.

According to this embodiment, phytosterol composition and the organo-chemical fungicide are preferably applied between physiological stage V5 to R5.5 of the cultivated soybeans.

According to a second specific embodiment related to the use of fluxapyroxad, the method comprises the organo-chemical fungicide comprising an effective amount of fluxapyroxad and the at least one phytosterol composition are applied separately.

Advantageously, the organo-chemical fungicide comprising an effective amount of fluxapyroxad is applied between two applications of the at least one phytosterol composition.

In that specific embodiment, both phytosterol compositions are preferably identical.

According to this embodiment, phytosterol composition and the organo-chemical fungicide are preferably applied between physiological stage V5 to R5.5 of the cultivated soybeans.

According to a third specific embodiment related to the use of fluxapyroxad, the method comprises at least two applications of a fungicide composition comprising at least one organo-chemical fungicide, said at least one organo-chemical fungicide comprising an effective amount of fluxapyroxad. In other words, the method comprises two applications with an effective amount of fluxapyroxad.

Advantageously, the organo-chemical fungicide comprising an effective amount of fluxapyroxad and the at least one phytosterol composition are applied concomitantly. In that specific embodiment, both phytosterol compositions are preferably identical.

In a preferred embodiment, at least a third, or preferentially the half of the total applications of the sequence of treatment is performed with a concomitant combination of a fungicide composition comprising at least one organo-chemical fungicide with a phytosterol composition comprising at least one phytosterol and at least one sucrose fatty acid ester.

According to one aspect, the invention relates to a slurry resulting from the dilution of the phytosterol composition in combination with a fungicide composition comprising at least one organo-chemical fungicide as previously described to be applied on soybean so as to increase yield and/or to reduce the effect of diseases. This slurry is performed by diluting the said combination, usually in water, at a concentration ranging from 0.001% to 50%, advantageously from 0.01% to 10%, preferably from 0.1% to 5%.

One option is to tank-mix two separate formulations, respectively the phytosterol composition and at least one active ingredient, in particular at least one organo-chemical fungicide, and then to dilute the mix in water (in all possible orders) to prepare the slurry. Another option is to dilute the phytosterol composition in order to obtain the slurry and only then, to add to the slurry a fungicide composition comprising at least one organo-chemical fungicide. Another option is to dilute in water a premix comprising in the same formulation a fungicide composition comprising at least one organo-chemical fungicide and the phytosterol composition. In such cases, the phytosterol composition and the fungicide composition comprising at least one organo-chemical fungicide are sprayed on soybean at the same time. All these embodiments are specific to the case where the phytosterol composition and the fungicide composition are applied together from the same tank.

Another option is to perform the treatment of cultivated soybean with the phytosterol composition used in the method of the invention combined with the fungicide composition comprising at least one organo-chemical fungicide, but the said phytosterol composition (hereafter designed as “A”) is not mixed in the same tank with the said fungicide composition comprising at least one organo-chemical fungicide (hereafter designed as “B”) but are used separately. This option comprises one of these situations:
A and B are in two or more different tanks but on the same vehicle, the vehicle being a human, an animal, a flying or driving machine carrying or comprising any equipment suitable to spray a liquid,
A and B are in two or more different tanks in two or more different vehicles, then
   A and B are sprayed on the same soybeans on the same day,
   A is sprayed and B is sprayed from one to three days after A has been sprayed,
   B is sprayed and A is sprayed from one to three days after B has been sprayed.

Advantageously, the phytosterol composition represents between 0.001% and 50% of the tank-mix composition and the fungicide composition represents between 0.001% and 50% of the tank-mix composition.

According to another aspect, the invention concerns a composition comprising:
(i) an effective amount of at least one organo-chemical fungicide selected in the group consisting of: bixafen, fluxapyroxad, benzovindiflupyr, fluindapyr, inpyrfluxam and their mixtures, advantageously at least fluxapyroxad, and
(ii) an effective amount of at least one phytosterol composition comprising at least one phytosterol and at least one sucrose fatty acid ester.

In that embodiment, the composition has for example the form of a premix which is diluted in water in order to obtain a slurry as explained above.

The invention also concerns a kit comprising:
(i) at least one organo-chemical fungicide selected from the group consisting of: bixafen, fluxapyroxad, benzovindiflupyr, fluindapyr, inpyrfluxam and their mixtures, advantageously at least fluxapyroxad, and
(ii) at least one phytosterol composition comprising at least one phytosterol and at least one sucrose fatty acid ester.

In that embodiment, the two separate formulations are tank-mixed as explained above.

In other words, the invention also concerns a slurry resulting from the dilution of the composition or of the kit.

The said at least one phytosterol present in the composition or in the kit is selected from the group consisting of: beta-sitosterol, campesterol, brassicasterol, stigmasterol, lanosterol, stigmastanol, campestanol, cycloartenol, gamma-sitosterol, Δ5-avenasterol, Δ7-avenasterol, isofucosterol, 5-dehydroepisterol, chlerosterol, sitostanol, stigmastadioenol, cholesterol, cholestanol, dinosterol, ergosterol, obtusifoliol, and mixtures thereof.

Advantageously, the said at least one phytosterol is a mixture of phytosterols containing B-sitosterol, which represents at least 30% of the phytosterols mixture by weight, with the balance to 100% containing, where appropriate, campesterol, stigmasterol, cholesterol and brassicasterol.

Preferably, the said at least one sucrose fatty acid ester is selected from the group consisting of: sucrose stearate, sucrose palmitate, their polyesters and mixture thereof.

According to a specific embodiment, the mass ratio between said at least one phytosterol and said at least one sucrose fatty acid ester is between 0.01 and 10, advantageously between 0.1 and 5, preferably between 0.2 and 1.5.

Advantageously,
said at least one phytosterol represents between 0.2% and 10% of the composition by weight; and
said at least one sucrose fatty acid ester represents between 0.2% and 10% of the composition by weight.

According to a specific embodiment, the at least one phytosterol composition further comprises boron and molybdenum or nitrogen instead of molybdenum.

According to a specific embodiment, the composition comprises an effective amount of fluxapyroxad and an effective amount of at least one strobilurin fungicide and/or an effective amount of at least one conazole, or optionally triazole fungicide.

The invention is also directed to a slurry resulting from the dilution of the above composition or the kit.

The at least one organo-chemical fungicide in combination with the phytosterol composition is effective since the first application on soybean, but is even more effective with at least two applications. In particular, this method is highly effective against Asian soybean rust, cercospora leaf blight, target spot, powdery mildew, anthracnose and end-of-cycle diseases such as purple seed stain and brown spot, and/or New World soybean rust. This method is even more effective against Asian soybean rust.

The invention also relates to a method of using the composition or slurry as previously described to improve the effectiveness of phytopharmaceutical organo-chemical fungicides or biocontrol products, by increasing the harvest yield of soybeans treated with this method. The increase of the harvest yield is expected to be more than 2%, or more than 5%, or more than 10%, even more than 15% the harvest yield of soybeans grown under similar conditions but treated only with the organo-chemical fungicide treatment.

The invention further relates to a method of using the composition or slurry as previously described to improve the effectiveness of phytopharmaceutical organo-chemical fungicides or biocontrol products, by increasing the control of fungal diseases of soybean. The said increase of control of fungal disease is expected to be more than 2%, or more than 5%, or more than 10%, even more than 20%, or even more than 25% compared to soybeans grown under similar conditions but treated only with the organo-chemical fungicide treatment.

In practice, the at least one sucrose fatty acid ester eases the phytosterol uptake through the cuticle of soybean leaves, then the soybean defense mechanism is triggered by the at least one phytosterol. On the condition that the composition or slurry is applied preferably prior to the onset the disease, a systemic action is observed, leading in turn to an enhanced fight against biotic stress.

The invention also relates to a method of using the phytosterol composition or slurry as previously described to treat in a preventive or in a curative way other plant species, whose harvest yield may be decreased while exposed to Phakopsora pachyrhizi or other common fungal diseases. These other plant species belong to the family of Fabaceae, more precisely the subfamily Faboideae, even more precisely pea, fava bean, lupine, clover or fenugreek.

The invention and the benefits it produces are more visible in the following examples, which are given in order to illustrate the invention in a non-exhaustive fashion. In particular, the examples show that all the cultivars that have been tested show a positive response on the treatment with the composition of the invention.

### EMBODIMENTS

The present disclosure is further defined by the following numbered embodiments:
1. A method of cultivating soybean exposed to at least one fungal disease comprising a step of applying to said cultivated soybean a combination comprising (i) an effective amount of at least one fungicide composition comprising at least one organo-chemical fungicide, and (ii) an effective amount of at least one phytosterol composition comprising at least one phytosterol and at least one sucrose fatty acid ester, wherein at least two applications of said at least one phytosterol composition are combined with at least two applications of said at least one fungicide composition, wherein at least one organo-chemical fungicide comprises an effective amount of Fluxapyroxad.
2. The method of embodiment 1, wherein the treatment with said combination: (i) increases the yield of said cultivated soybean in comparison to soybeans under similar conditions treated only with the organo-chemical fungicide treatment and/or (ii) reduces the effects of said at least one fungal disease on said field of cultivated soybean in comparison to soybeans under similar conditions only treated with the organo-chemical fungicide treatment.
3. The method of embodiment 1, wherein the treatment with said combination (iii) sustains the yield of said cultivated soybean in comparison to soybeans under similar conditions treated with a reduced dose of the fungicide composition comprising at least one organo-chemical fungicide, wherein the organo-chemical dose reduction is at least 10%.
4. The method of any of embodiment 1 or 2, or 3, wherein it comprises at least two applications of at least one organo-chemical fungicide, one application only being an organo-chemical fungicide comprising fluxapyroxad.
5. The method of embodiment 4, wherein the organo-chemical fungicide comprising an effective amount of fluxapyroxad and the at least one phytosterol composition are applied concomitantly.
6. The method of embodiment 5, wherein at least one phytosterol composition is applied prior to the application of the organo-chemical fungicide comprising an effective amount of Fluxapyroxad and at least one phytosterol composition.
7. The method of embodiment 6, wherein the at least one phytosterol composition which is applied concomitantly with the organo-chemical fungicide comprising an effective amount of Fluxapyroxad and the at least one phytosterol composition which is applied prior the application of the organo-chemical fungicide comprising an effective amount of Fluxapyroxad and at least one phytosterol composition are identical.
8. The method of embodiment 7, wherein phytosterol composition and the organo-chemical fungicide are applied between physiological stage V5 to R5.5 of the cultivated soybeans.
9. The method of embodiment 4, wherein the organo-chemical fungicide comprising an effective amount of Fluxapyroxad and the at least one phytosterol composition are applied separately.
10. The method of embodiment 9, wherein the organo-chemical fungicide comprising an effective amount of Fluxapyroxad is applied between two applications of the at least one phytosterol composition.
11. The method of embodiment 10, wherein phytosterol compositions are identical.
12. The method of embodiment 11, wherein phytosterol composition and the organo-chemical fungicide are applied between physiological stage V5 to R5.5 of the cultivated soybeans.
13. The method of any of embodiment 1 or 2, or 3, wherein it comprises at least two applications of at least one organo-chemical fungicide, said at least one organo-chemical fungicide comprising an effective amount of fluxapyroxad.
14. The method of embodiment 13, wherein the organo-chemical fungicide comprising an effective amount of Fluxapyroxad and the at least one phytosterol composition are applied concomitantly.
15. The method of embodiment 14, wherein phytosterol compositions of the at least two applications are identical.
16. The method of any of embodiment 1 or 2, or 3, wherein the effective treatment with at least one organo-chemical fungicide is a standard treatment with respect to regime and dosage as recommended for the treatment of soybean.
17. The method of any of embodiment 1 or 2, or 3, wherein the organo-chemical fungicide comprising an effective amount of fluxapyroxad further comprises an effective amount of at least one strobilurin fungicide.
18. The method of any of embodiment 1 or 2, or 3, wherein the mixture comprising an effective amount of Fluxapyroxad further comprises an effective amount of at least one conazole or triazole fungicide.
19. The method of any of embodiment 1 or 2, or 3, wherein said at least one fungal disease is caused by a fungus from the subkingdom Dikarya.
20. The method of any of embodiment 1 or 2, or 3, wherein said at least one fungal disease is caused by a fungus from the division Basidiomycota or Ascomycota.
21. The method of any of embodiment 1 or 2, or 3, wherein said at least one fungal disease is caused by a fungus from the class selected from Pucciniomycetes, Sordariomycetes, Dothideomycetes or Leotiomycetes.
22. The method of embodiment 21, wherein said at least one fungal disease is selected from the group consisting of Asian soybean rust; anthracnose; end-of-cycle diseases, advantageously purple seed stain and brown spot; target spot; powdery mildew; cercospora leaf blight; New World soybean rust; and combination thereof.
23. The method of embodiment 22, wherein said at least one fungal disease is Asian soybean rust.
24. A composition comprising (i) an effective amount of fluxapyroxad, and (ii) an effective amount of at least one phytosterol composition comprising at least one phytosterol and at least one sucrose fatty acid ester.
25. The composition of embodiment 24, wherein the organo-chemical fungicide further comprises an effective amount of at least one strobilurin fungicide.
26. The composition of embodiment 24, wherein the organo-chemical fungicide further comprises an effective amount of at least one conazole or triazole fungicide.
27. A kit comprising (i) Fluxapyroxad, and (ii) at least one phytosterol composition comprising at least one phytosterol and at least one sucrose fatty acid ester.
28. The kit of embodiment 27, wherein it further comprises strobilurin fungicide.
29. The kit of embodiment 27, wherein it further comprises one conazole or triazole fungicide.
30. Slurry resulting from the dilution of the composition according to embodiment 24 or the kit of embodiment 25.
31. The method of any of embodiment 1 or 2, or 3, or the composition of embodiment 24, or the kit of embodiment 27, wherein said at least one phytosterol is selected from the group consisting of: beta-sitosterol, campesterol, brassicasterol, stigmasterol, lanosterol, stigmastanol, campestanol, cycloartenol, gamma-sitosterol, Δ5-avenasterol, Δ7-avenasterol, isofucosterol, 5-dehydroepisterol, chlerosterol, sitostanol, stigmastadioenol, cholesterol, cholestanol, dinosterol, ergosterol, obtusifoliol, and mixtures thereof.
32. The method of any of embodiment 1 or 2, or 3, or the composition of embodiment 24, or the kit of embodiment 31, wherein said at least one phytosterol is a mixture of phytosterols containing β-sitosterol.
33. The method of any of embodiment 1 or 2, or 3, or the composition of embodiment 24, or the kit of embodiment 32, wherein said at least one phytosterol is a mixture of phytosterols containing B-sitosterol, which represents at least 30% of the phytosterols mixture by weight, with the balance to 100% containing, where appropriate, campesterol, stigmasterol and brassicasterol.
34. The method of any of embodiment 1 or 2, or 3, or the composition of embodiment 24, or the kit of embodiment 27, wherein said at least one sucrose fatty acid ester is selected from the group consisting of: sucrose stearate, sucrose palmitate, their polyesters and mixture thereof.
35. The method of any of embodiment 1 or 2, or 3, or the composition of embodiment 24 or the kit of embodiment 27, wherein the mass ratio between said at least one phytosterol and said at least one sucrose fatty acid ester is between 0.01 and 10, advantageously between 0.1 and 5, preferably between 0.2 and 1.5.
36. The method of any of embodiment 1 or 2, or 3, or the composition of embodiment 24 or the kit of embodiment 27, wherein: said at least one phytosterol represents between 0.2% and 10% of the phytosterol composition by weight; and said at least one sucrose fatty acid ester represents between 0.2% and 10% of the phytosterol composition by weight.
37. The method of any of embodiment 1 or 2, or 3, wherein the total concentration of said at least one phytosterol applied on cultivated soybean is between 2.5 g/ha to 250 g/ha.
38. The method of any of embodiment 1 or 2, or 3, wherein the total concentration of said at least one phytosterol applied on cultivated soybean is between 12.5 and 125 g/ha.
39. The method of any of embodiment 1 or 2, or 3, wherein the total concentration of said at least one phytosterol applied on cultivated soybean is between 25 g/ha and 100 g/ha.

### EXAMPLES OF APPLICATION OF THE INVENTION

### 1. Preparation of a Phytosterol Composition Used in the Method of the Invention

a. As a Form of a Suspo-Emulsion

The formulation of the phytosterol composition used in the method of the invention is a suspo-emulsion comprising the compounds of Table 1.

TABLE 1
Phytosterol composition.

| Compound (wt %) | Formulation 1 | Formulation 2 |
|---|---|---|
| Phytosterols, CAS: | 2.5 | 5 |
| 949109-75-5 | | |
| Sucrose stearate, | 6 (surfactant acting in oil-in- | 10 + 2 |
| CAS: 84066-95-5 | water emulsion) + 2 (free | |
| | surfactant in suspension) | |
| Polyethylene glycol | 3.5 | 5 |
| Methyl tetradecanoate | 0.4 | — |
| Water | 85.2 | 76.36 |
| Preservative | Benzyl alcohol 0.7 | EDTA 0.04 |
| | | Phenethyl |
| | | alcohol 0.5 |
| Nutrients | Boron 0.25 | Boron 0.10 |
| | Molybdenum 0.09 | Nitrogen 1.00 |
| Dv90 suspo-emulsion | 80 | 70 |
| (μm) | | |

The suspo-emulsions according to the invention are manufactured comprising the following steps:
(i) Preparation at about 110° C. of a lipophilic phase comprising phytosterols, sucrose stearate, methyl tetradecanoate, and solvent,
(ii) Preparation at a given temperature of a hydrophilic phase comprising water and benzyl alcohol if any,
(iii) Mixing the lipophilic phase of step (i) with the hydrophilic phase of step (ii) and stirring until at least 90% of the volume of lipophilic droplets with a diameter comprised between 0.1 and 20 μm are obtained, with a maximum peak between 2 and 6 μm as determined by laser diffraction,
(iv) Cooling the emulsion to ambient temperature of about 20° C., and
(v) Adding sucrose stearate in the oil-in-water emulsion, at ambient temperature of about 20° C. and stirring until at least 90% of the particles with a diameter comprised between 10 and 250 μm are obtained and suspended in the aqueous phase, with a maximum peak between 10 μm and 1000 μm as determined by laser diffraction.
   b. As a Form of a Suspension

The formulation of the phytosterol composition used in the method of the invention is a suspension comprising the compounds of Table 2.

TABLE 2
Phytosterol composition.

| Compound (wt %) | Formulation 3 |
|---|---|
| Phytosterols, CAS: 949109-75-5 | 2.0 |
| Sucrose stearate, CAS: 84066-95-5 | 10 |
| Polyethylene glycol, molar mass 400 g/mol | 3.5 |
| Water | 84.9 |
| Benzyl alcohol | 0.7 |
| Dv90 (μm) | 80 |

The suspension according to the invention is manufactured comprising the following steps:
(i) Preparation of an aqueous suspension comprising the above-mentioned compounds in water.
(ii) Grinding the mixture of (i) until a particle size distribution under 100 μm is obtained, for instance using a mortar and a pestle or a bead mill.

### 2. Agricultural Mixtures With Commercial Organo-Chemical Fungicides. Control of Asian Soybean Rust, Anthracnose, Purple Seed Stain and Brown Spot in Field Trials and Increase of the Harvest Yield

The objective of the trial is to demonstrate the efficiency of a phytosterol composition comprising at least one phytosterol and at least one sucrose fatty acid ester, when combined with commercial organo-chemical fungicides to fight against soybean diseases, i.e. Asian soybean rust, anthracnose, purple seed stain and brown spot, when the phytosterol composition is applied twice, before and after emergence of the diseases.

a. Materials and Methods

Experiments were conducted with a phytosterol composition in the form of a suspo-emulsion as “formulation 1” in example 1. The following mixtures were prepared, each of them containing both DMI-based and QₒI-based fungicides. Table 3 summarizes the different experiments. Four sequential applications of the products were performed, including one before flowering.

TABLE 3
Different experiments where the phytosterol composition is mixed with
organo-chemical fungicides (treatments B-G). Sowing is at day 0.

| | | | Dose | Sterol |
|---|---|---|---|---|
| | Application | | (L/ha or | rate |
| Experiment | number^{#} | Mixture^{†} | kg/ha)* | (g/ha) |
| A | — | Untreated | — | 0 |
| B | 1 (day 51, | Phytosterol formulation 1 | 2.0 | 50 |
| | stage V5) | Trifloxystrobin/Cyproconazole | 0.2 | |
| | | Chlorothalonil | 1.0 | |
| | 2 (day 66, | Fluxapyroxad/Pyraclostrobin | 0.35 | 0 |
| | stage R1) | Mancozeb | 1.5 | |
| | 3 (day 81, | Bixafen/Prothioconazole/Trifloxystrobin | 0.5 | 0 |
| | stage R3) | Mancozeb | 1.5 | |
| | 4 (day 101, | Trifloxystrobin/Cyproconazole | 0.2 | 0 |
| | stage R5.3) | Difenoconazole/Cyproconazole | 0.3 | |
| C | 1 | Trifloxystrobin/Cyproconazole | 0.2 | 0 |
| | | Chlorothalonil | 1.0 | |
| | 2 | Phytosterol formulation 1 | 2.0 | 50 |
| | | Fluxapyroxad/Pyraclostrobin | 0.35 | |
| | | Mancozeb | 1.5 | |
| | 3 | Bixafen/Prothioconazole/Trifloxystrobin | 0.5 | 0 |
| | | Mancozeb | 1.5 | |
| | 4 | Trifloxystrobin/Cyproconazole | 0.2 | 0 |
| | | Difenoconazole/Cyproconazole | 0.3 | |
| D | 1 | Trifloxystrobin/Cyproconazole | 0.2 | 0 |
| | | Chlorothalonil | 1.0 | |
| | 2 | Fluxapyroxad/Pyraclostrobin | 0.35 | 0 |
| | | Mancozeb | 1.5 | |
| | 3 | Phytosterol formulation 1 | 2.0 | 50 |
| | | Bixafen/Prothioconazole/Trifloxystrobin | 0.5 | |
| | | Mancozeb | 1.5 | |
| | 4 | Trifloxystrobin/Cyproconazole | 0.2 | 0 |
| | | Difenoconazole/Cyproconazole | 0.3 | |
| E | 1 | Phytosterol formulation 1 | 1.0 | 25 |
| | | Trifloxystrobin/Cyproconazole | 0.2 | |
| | | Chlorothalonil | 1.0 | |
| | 2 | Phytosterol formulation 1 | 1.0 | 25 |
| | | Fluxapyroxad/Pyraclostrobin | 0.35 | |
| | | Mancozeb | 1.5 | |
| | 3 | Bixafen/Prothioconazole/Trifloxystrobin | 0.5 | 0 |
| | | Mancozeb | 1.5 | |
| | 4 | Trifloxystrobin/Cyproconazole | 0.2 | 0 |
| | | Difenoconazole/Cyproconazole | 0.3 | |
| F | 1 | Phytosterol formulation 1 | 1.0 | 25 |
| | | Trifloxystrobin/Cyproconazole | 0.2 | |
| | | Chlorothalonil | 1.0 | |
| | 2 | Fluxapyroxad/Pyraclostrobin | 0.35 | 0 |
| | | Mancozeb | 1.5 | |
| | 3 | Phytosterol formulation 1 | 1.0 | 25 |
| | | Bixafen/Prothioconazole/Trifloxystrobin | 0.5 | |
| | | Mancozeb | 1.5 | |
| | 4 | Trifloxystrobin/Cyproconazole | 0.2 | 0 |
| | | Difenoconazole/Cyproconazole | 0.3 | |
| G | 1 | Trifloxystrobin/Cyproconazole | 0.2 | 0 |
| | | Chlorothalonil | 1.0 | |
| | 2 | Phytosterol formulation 1 | 1.0 | 25 |
| | | Fluxapyroxad/Pyraclostrobin | 0.35 | |
| | | Mancozeb | 1.5 | |
| | 3 | Phytosterol formulation 1 | 1.0 | 25 |
| | | Bixafen/Prothioconazole/Trifloxystrobin | 0.5 | |
| | | Mancozeb | 1.5 | |
| | 4 | Trifloxystrobin/Cyproconazole | 0.2 | 0 |
| | | Difenoconazole/Cyproconazole | 0.3 | |
| H | 1 | Trifloxystrobin/Cyproconazole | 0.2 | 0 |
| | | Chlorothalonil | 1.0 | |
| | 2 | Fluxapyroxad/Pyraclostrobin | 0.35 | 0 |
| | | Mancozeb | 1.5 | |
| | 3 | Bixafen/Prothioconazole/Trifloxystrobin | 0.5 | 0 |
| | | Mancozeb | 1.5 | |
| | 4 | Trifloxystrobin/Cyproconazole | 0.2 | 0 |
| | | Difenoconazole/Cyproconazole | 0.3 | |

^{#}The treatments were performed the same day for all experiments.
^{†}All mixtures contained an adjuvant for better efficacy. Trifloxystrobin/Cyproconazole is Sphere Max ®; Chlorothalonil is Bravonil ®; Fluxapyroxad/Pyraclostrobin is Orkestra SC ™; Mancozeb is Unizeb gold ®; Bixafen/Prothioconazole/Trifloxystrobin is Fox Xpro ®; Trifloxystrobin/Cyproconazole is Sphere Max ®; Difenoconazole/Cyproconazole is Cypress 400EC ®.
*This value stands for the non-diluted product. All organo-chemical fungicides were diluted at their recommended dilution before being applied to soybeans.

Phytosterol formulation 1 was diluted at 1% in water to prepare the slurry. The organo-chemical fungicides were tank-mixed together with the slurry of the said phytosterol compositions. Experiment A corresponds to an untreated control. All other treatments were conducted with the same sequence of organo-chemical fungicides, at the same field dose. Treatment H corresponds to a treated experiment with commercial organo-chemical fungicides only, according to standard agricultural practice. Treatments B-D are comparison examples where the phytosterol-based composition is applied once in the treatment sequence at a rate of 50 g/ha, at various stages. Treatments E-G are examples where the phytosterol composition is applied twice at a rate of 25 g/ha and in combination with at least two applications of at least one organo-chemical fungicide, at various stages. It is noteworthy that the same final concentration of phytosterols was applied in all treatments B-G, i.e. 50 g/ha.

Four different diseases were observed in this study: Asian soybean rust, anthracnose and end-of-cycle diseases (purple seed stain and brown spot). All were evaluated in terms of severity evolution with time. The data relating to disease severity were transformed by the square root test \sqrt{ } x+k, and if significant, it was subjected to the Tukey test (p <0.05). The efficiency of treatments was calculated as: Efficiency (E %)=[(u−t)/u]×100 where u is the infestation (or severity) in the untreated control and t is the infestation (or severity) in the studied treatment.

b. Description of the Experimental Plot

The description of the experimental plot is presented in Table 4. The experimental plot was not subjected to drought or thermal stress.

TABLE 4
Experimental plot

| Crop (variety) | Soybean (B53C22 Conventional) |
|---|---|
| Sowing density | 280,000 plants/ha |
| Soil type | Deep soil (silt/clay) |
| Experimental setup | Microplots (25 m²) |
| Blooming (days after sowing) | Around day 60 |
| Harvest (days after sowing) | 130 |

c. Results
i. Asian Soybean Rust

The results are given in Table 5. The efficiency of the treatment calculated at the last application is given either against the untreated experiment (A) or against the standard organo-chemical fungicide treatment (H).

TABLE 5
Control of Asian soybean rust

| | Asian soybean rust severity (%) | | | | | |
|---|---|---|---|---|---|---|
| | Application | Application | Application | Application | Efficiency (%) | |
| Experiment | 1 | 2 | 3 | 4 | Vs. A | Vs. H |
| A | 0 | 13.2 a | 34.4 a | 74.8 a | — | −205.3 |
| B | 0 | 4.1 bcd | 8.1 bc | 16.2 cde | 78.3 | 33.9 |
| C | 0 | 4.2 bcd | 8.8 bc | 18.5 bcd | 75.3 | 24.5 |
| D | 0 | 5.8 b | 11.6 b | 23.7 bc | 68.3 | 3.3 |
| E | 0 | 2.3 d | 4.9 c | 9.8 e | 86.9 | 60.0 |
| F | 0 | 3.1 d | 6.5 c | 13.1 de | 82.5 | 46.5 |
| G | 0 | 3.3 cd | 7.5 bc | 14.4 de | 80.7 | 41.2 |
| H | 0 | 5.8 bc | 12.5 b | 24.5 b | 67.2 | — |

ii. Anthracnose

The results are given in Table 6.

TABLE 6
Control of anthracnose

| | Anthracnose severity (%) | | | | | |
|---|---|---|---|---|---|---|
| | Application | Application | Application | Application | Efficiency (%) | |
| Treatment | 1 | 2 | 3 | 4 | Vs. A | Vs. H |
| A | 0 | 7.3 a | 14.7 a | 29.0 a | — | −181.6 |
| B | 0 | 1.8 b | 3.7 b | 7.9 b | 72.8 | 23.3 |
| C | 0 | 2.1 b | 4.5 b | 8.6 bc | 70.3 | 16.5 |
| D | 0 | 2.3 b | 4.9 b | 9.5 bc | 67.2 | 7.8 |
| E | 0 | 1.0 b | 2.4 b | 5.0 c | 82.8 | 51.5 |
| F | 0 | 1.4 b | 2.8 b | 7.5 bc | 74.1 | 27.2 |
| G | 0 | 1.6 b | 3.7 b | 7.5 bc | 74.1 | 27.2 |
| H | 0 | 2.1 b | 4.8 b | 10.3 b | 64.5 | — |

iii. End-of-Cycle Diseases

The results are given in Table 7.

TABLE 7
Control of end-of-cycle diseases

| | End-of-cycle diseases severity (%) | | | | | |
|---|---|---|---|---|---|---|
| | Application | Application | Application | Application | Efficiency (%) | |
| Experiment | 1 | 2 | 3 | 4 | Vs. A | Vs. H |
| A | 0 | 8.5 a | 17.0 a | 37.3 a | — | −178.4 |
| B | 0 | 2.5 bc | 5.0 bcd | 10.5 bc | 71.8 | 21.6 |
| C | 0 | 2.9 b | 5.9 bc | 11.7 b | 68.6 | 12.7 |
| D | 0 | 3.0 b | 6.0 bc | 13.2 b | 64.6 | 1.5 |
| E | 0 | 1.3 c | 2.7 d | 6.1 c | 83.6 | 54.5 |
| F | 0 | 1.5 c | 3.4 cd | 7.0 c | 81.2 | 47.8 |
| G | 0 | 1.9 bc | 3.9 bcd | 8.5 bc | 77.2 | 36.6 |
| H | 0 | 2.0 bc | 6.3 b | 13.4 b | 64.1 | — |

d. Harvest Yield

The values of the harvest yield are given in Table 8. The relative values are expressed versus the untreated soybean (A) or versus the treatment performed with commercial organo-chemical fungicides, that is to say experiment H.

TABLE 8
Harvest yield

| | Harvest yield | % harvest | % harvest |
|---|---|---|---|
| Experiment | (kg/ha) | vs. A | vs. H |
| A - untreated | 2026 d | — | −48.2 |
| B | 4201 b | +107.4 | +7.2 |
| C | 4194 b | +107.0 | +7.0 |
| D | 3927 c | +93.8 | +0.2 |
| E | 4487 a | +121.5 | +14.5 |
| F | 4332 ab | +113.8 | +10.5 |
| G | 4294 ab | +111.9 | +9.6 |
| H - fungicide only | 3918 c | +93.4 | — |

e. Interpretation of Results
Without any treatment against the soybean diseases (A), the harvest was reduced by 48% compared to the fungicide-only treated modality (H), showing the effect of the disease pressure on soybean harvest yield.
No phytotoxicity of the treatments was observed in this experiment.
Despite a very high intensity of Asian soybean rust (Table 5), all treatments allowed reducing the pressure of the disease from three up to eight times, with experiments B-G (which include the phytosterol formulation) giving the best results.
Application number 1 (day 51) was performed before the emergence of any diseases; therefore, this application was preventive.
All treatments which include phytosterols performed better than the experiment H (no phytosterol composition), which consisted in a state-of-the-art treatment of soybean with commercial organo-chemical fungicides. Performing better means that both harvest yield and efficiency to control diseases were improved over treatment H.
Treatment E performed better than any other treatments. It consisted in two applications, performed during the first and second runs of the sequence of four applications. Treatment E was able to reduce both the severity of the diseases (i.e., increase the efficiency of the treatment) and showed the highest harvest yield.
Among the treatments which involve the use of phytosterols:
   Double application of the phytosterol formulation at half rate performed better than single application at full rate. Indeed, double application of the phytosterol formulation has a synergistic effect in terms of increasing yield and controlling the severity of disease. Regarding Table 3:

$$\begin{matrix}\begin{matrix}Treatment E = treatment B + treatment C ; \\ Treatment F = treatment B + treatment D ; and\end{matrix} \\ Treatment G = treatment C + treatment D .\end{matrix}$$

As a demonstration, treatment F induces a synergetic effect in controlling Asian soybean rust (see Table 5), since the efficiency of treatment Fis 46.5% greater than the additivity of the effects of treatments B and D (i.e. 37.2%). The same applies to the other dual applications tested on other diseases. Besides, regarding harvest yield, treatment F induces a synergetic effect (see Table 8), since the “% harvest vs. treatment H” of treatment F is 10.5%, which is higher than the additivity of the effects of treatments B and D (i.e. 7.4%). The same applies to the other dual applications tested.
Early applications work better (applications 1 and 2, experiment E) rather than delayed applications (experiment G).

### 3. Agricultural Mixtures With Commercial Organo-Chemical Fungicides. Preventive and Curative Treatment Against Purple Seed Stain and Brown Spot in Field Trials and Increase of Harvest Yield

The objective of the trial is to demonstrate the efficiency of a phytosterol composition exemplified as formulation 1 of example 1, combined with commercial organo-chemical fungicides to improve the yield and to control the disease compared to an fungicide-only, cultivated soybean, both in preventive and curative treatments, and the effect of these treatments on several parameters, such as phytotoxicity or chlorophyll content.

a. Materials and Methods

Experiments were conducted with a phytosterol composition exemplified as formulation 1 from example 1 which was combined with a standard organo-chemical fungicide treatment.

Table 9 summarizes the different experiments. The products were applied at different phenological stages.

TABLE 9
Different experiments where the phytosterol composition is mixed with
organo-chemical fungicides (treatments B-G). Sowing is at day 0.

| | | Dose according to application stage^{#} | | | |
|---|---|---|---|---|---|
| | | (L/ha) | | | Total |
| | | V4 stage | R1 stage | R3 stage | phytosterols |
| Experiment | Product | Day 26 | Day 47 | Day 68 | (g/ha) |
| A | Fungicide | — | — | — | — |
| | only | | | | |
| B | Phytosterol | 2 | | | 50 |
| C | composition | | 2 | | 50 |
| D | | | | 2 | 50 |
| E | | 2 | 2 | | 100 |
| F | | 2 | | 2 | 100 |
| G | | | 2 | 2 | 100 |

^{#}See next Table for the timeline of the three applications.

Experiment A corresponds to a soybean modality which has been treated in organo-chemical fungicides. In addition to the treatments with the composition of the invention, the field was also treated with commercial organo-chemical fungicides, which were applied the same day as the application of the phytosterol composition but not from the same tank mix.

Table 10 summarizes the timeline of the three applications of the phytosterol composition, which are part of a full agricultural itinerary.

TABLE 10
Timeline of applications of commercial organo-chemical
fungicides and/or product of the invention

| | | Application of | Plant |
|---|---|---|---|
| Day | Organo-chemical fungicide^{†} (g or L/ha) | phytosterols | stage |
| 26 | Bixafen/Prothioconazole/Trifloxystrobin | Yes | V4 |
| | (0.5) | | |

Flowering of soybean

| | | | |
|---|---|---|---|
| 47 | Bixafen/Prothioconazole/Trifloxystrobin | Yes | R1 |
| | (0.5) | | |
| 68 | Azoxystrobin/Tebuconazole (0.5) | Yes | R3 |
| 82 | Bixafen/Prothioconazole/Trifloxystrobin | No | |
| | (0.5) | | |
| 97 | Azoxystrobin/Tebuconazole (0.5) | No | |

^{†}Bixafen/Prothioconazole/Trifloxystrobin is Fox Xpro ®; Azoxystrobin/Tebuconazole is Azimut ®.

Two different diseases were considered in this study, which belong to the so-called end-of-cycle diseases: purple seed stain and brown spot; they were considered as a whole.

b. Description of the Experimental Plot

The description of the experimental plot is presented in Table 11. The experimental plot was not subjected to any drought or thermal stress.

TABLE 11
Experimental plot.

| Crop (variety) | Soybean (Brasmax Desafio) |
|---|---|
| Sowing density | 440,000 plants/ha |
| Soil type | Sand/clay |
| Experimental setup | Microplots (15 m²) |
| Blooming (days after sowing) | Around day 46 |
| Harvest (days after sowing) | 120 |

c. Results
i. End-of-Cycle Diseases

The protection efficiency of each experiment was controlled seven days after their application. The results are given in Table 12.

TABLE 12
Control of end-of-cycle diseases

Severity of end-of-cycle diseases (%)

| | Application | Application | Application |
|---|---|---|---|
| Experiment | 1 | 2 | 3 |
| A - fungicide | 0 | 3.33 | 7.65 |
| only | | | |
| B | 0 | 1.20 | 1.60 |
| C | 0 | 1.60 | 4.17 |
| D | 0 | 3.33 | 4.13 |
| E | 0 | 0.40 | 1.20 |
| F | 0 | 0.80 | 1.60 |
| G | 0 | 1.20 | 1.20 |

ii. Chlorophyll Content

The results of chlorophyll content given in Table 13 show a trend where the concentration is higher when the soybean has been treated with the phytosterol composition combined with organo-chemical fungicides. It means that the treated soybean has a better photosynthetic activity than the untreated. The analysis was performed 15 days after the last treatment.

TABLE 13
Chlorophyll content

| | Chlorophyll | |
|---|---|---|
| Experiment | content | % vs. A |
| A - fungicide | 52.48 | — |
| only | | |
| B | 54.73 | +4.3 |
| C | 53.77 | +2.5 |
| D | 53.27 | +1.5 |
| E | 55.97 | +6.7 |
| F | 54.68 | +4.2 |
| G | 55.60 | +5.9 |

d. Harvest Yield

The values of the harvest yield are given in Table 14. The relative values are expressed versus the untreated experiment (A). The harvest yields were not statistically significant one to another.

TABLE 14
Harvest yield

| Experiment | Harvest yield (kg/ha) | % harvest vs. fungicide only (A) |
|---|---|---|
| A - fungicide | 3650.5 a | — |
| only | | |
| B | 3999.7 a | +9.57 |
| C | 3862.7 a | +5.81 |
| D | 3825.5 a | +4.79 |
| E | 4429.0 a | +21.33 |
| F | 4091.4 a | +12.08 |
| G | 4146.7 a | +13.59 |

e. Interpretation of Results
The lowest harvest was obtained for the fungicide-only experiment (A).
No phytotoxicity of the treatments was observed in this experiment.
Even if soybean diseases are known to affect leaves, by maintaining the chlorophyll content the phytosterol composition allows soybean to keep photosynthesis, thus allowing to increase the harvest yield.
Treatment E performed better than the other treatments. It consisted in two applications at the highest rate of phytosterols sprayed on the plants (100 g/ha), performed during the first and second runs. Treatment E decreased the severity of the disease and showed the highest harvest yield.
Among the treatments which involve the use of phytosterols:
   A double application of phytosterols on the same soybean at two different stages gives better yields than treated said soybeans with a single application. Indeed, double application of the phytosterol composition has a synergistic effect in terms of increasing yield. Regarding Table 9:

$$\begin{matrix}\begin{matrix}Treatment E = treatment B + treatment C ; \\ Treatment F = treatment B + treatment D ; and\end{matrix} \\ Treatment G = treatment C + treatment D .\end{matrix}$$

As a demonstration, treatment E induces a synergetic effect in increasing the harvest yield (see Table 14), since the “% harvest” of treatment E is 21.33% which is greater than the sum of the effects of treatments B and C (i.e. 15.38%). The same applies to the other dual applications tested.
Early applications work better (applications at V4 and R1, treatment E) rather than delayed applications.
Applications where the total of phytosterols sprayed to the plants was 100 g/ha performed better than 50 g/ha.

### 4. Agricultural Mixtures With Commercial Organo-Chemical Fungicides, Wherein the Commercial Organo-Chemical Fungicide Comprises Fluxapyroxad

The objective of the trial is to demonstrate the benefit to combine fluxapyroxad (an organo-chemical fungicide) treatment with two applications of a phytosterol composition comprising at least one phytosterol and at least one sucrose fatty acid ester. These two combined applications are supplemented with three other organo-chemical fungicide applications.

a. Materials and Methods

Experiments were conducted with three different phytosterol compositions, namely formulations 1, 2 (suspo-emulsion) and 3 (aqueous suspension) of example 1, which were combined with a standard organo-chemical fungicide treatment comprising fluxapyroxad.

Table 15 summarizes the different experiments. The products were applied at two different phenological stages.

TABLE 15
Experiments conducted in this example.

| | | | | | | Total |
|---|---|---|---|---|---|---|
| | | | | | | phytosterols |
| Exp. | V6 | R1 | R1 + 14 | R5.2 | R5.5 | (g/ha) |
| A | No | No | No | No | No | — |
| B | Tebuconazole | Inpyrfluxam/ | Fenhexamide/ | Fluxapyroxad/ | Fluxapyroxad/ | — |
| | 0.35 L/ha | prothioconazole + | Fludioxonil + | prothioconazole | prothioconazole | |
| C | | Fluazinam | Fluazinam | Formulation | Formulation | 50 |
| | | 0.35 + 1.0 | 0.7 + 1.0 | 1 + | 1 + | |
| | | L/ha | L/ha | Fluxapyroxad/ | Fluxapyroxad/ | |
| | | | | prothioconazole | prothioconazole | |
| D | | | | Formulation | Formulation | 50 |
| | | | | 2 + | 2 + | |
| | | | | Fluxapyroxad/ | Fluxapyroxad/ | |
| | | | | prothioconazole | prothioconazole | |
| E | | | | Formulation | Formulation | 50 |
| | | | | 3 + | 3 + | |
| | | | | Fluxapyroxad/ | Fluxapyroxad/ | |
| | | | | prothioconazole | prothioconazole | |

R1 + 14 means 14 days after the R1 reproductive stage. Fluxapyroxad/prothioconazole is Blavity ® at 0.25 L/ha.

All phytosterol compositions of experiments C-E were diluted at 1% in water to prepare the slurry. When combined, the organo-chemical fungicides were tank-mixed together with the slurry of the said phytosterol compositions.

Experiment A corresponds to an untreated soybean, which was neither treated with phytosterols, nor with any fungicide.

Experiment B is a comparative example which corresponds to a soybean which has been treated with the same organo-chemical fungicides during the firth three runs, and an organo-chemical mixture containing fluxapyroxad, but no phytosterol.

Experiments C-E are examples which correspond to a soybean which has been treated with the same organo-chemical fungicides during the first three runs, then an organo-chemical fungicide comprising fluxapyroxad, along with a phytosterol composition according to formulations 1, 2 and 3 of example 1, respectively, applied at stages R5.2 and R5.5.

For all experiments except experiment A, the fungicide treatments performed at V6, R1 and R1+14 days are identical. They were performed with the adjunction of a wetting agent.

In experiments C-E, the phytosterol composition was added twice at 1 L/ha (exp. C and E, with 25 g/L of phytosterols) or 0.5 L/ha (exp. D, with 50 g/L of phytosterols), giving a total of 50 g/ha of phytosterols.

b. Description of the Experimental Plot

The description of the experimental plot is presented in Table 16.

TABLE 16
Experimental plot.

| Crop (variety) | Soybean (BMX Zeus IPRO) |
|---|---|
| Sowing density | 440,000 plants/ha |
| Experimental setup | Microplots (30 m²) |
| Harvest (days after sowing) | 133 |

c. Results

The protection efficiency of each experiment was estimated by calculating the area under the disease progress curve (AUDPC), and estimating the efficiency of the protection (ΣAUDPC) of a treated experiment against the untreated experiment (exp. A). The data were subjected to analysis of variance and the mean comparison test. Data regarding disease severity were transformed using the square root test \sqrt{ }x+k, and if significant, were subjected to the Tukey test (p<0.05).

i. Phakopsora pachyrhizi (Soybean Rust)

The results are given in Table 17.

TABLE 17
Control of Phakopsora pachyrizi.

| | | ΣAUDPC | |
|---|---|---|---|
| Experiment | AUDPC | (%) | |
| A | 1790 | 0 | g |
| B | 203 | 88.6 | abcd |
| C | 186 | 89.5 | abc |
| D | 280 | 84.3 | de |
| E | 244 | 86.3 | bcde |

The results show that experiments B-E reduced the fungal pressure of Asian soybean rust in a similar way. The global fungal pressure of Asian soybean rust was very high, as revealed by the high value of the AUDPC of untreated soybean A.

ii. End-of-Cycle Diseases (Cercospora kikuchii and Septoria glycines)

The results are given in Table 18.

TABLE 18
Control of end-of-cycle diseases

| | | ΣAUDPC | |
|---|---|---|---|
| Experiment | AUDPC | (%) | |
| A | 986.9 | 0 | e |
| B | 300.0 | 69.5 | abc |
| C | 287.4 | 70.9 | ab |
| D | 339.8 | 65.5 | bc |
| E | 308.0 | 68.8 | abc |

The results show that experiments B-E reduced the fungal pressure of end-of-cycle diseases in a similar way.

iii. Erysiphe diffusa (Powdery Mildew)

The results are given in Table 19.

TABLE 19
Control of Erysiphe diffusa

| | | ΣAUDPC | |
|---|---|---|---|
| Experiment | AUDPC | (%) | |
| A | 833.8 | 0 | c |
| B | 0 | 100 | a |
| C | 0 | 100 | a |
| D | 0 | 100 | a |
| E | 0 | 100 | a |

The results show that experiments B-E eradicated powdery mildew.

d. Harvest Yield

The values of the harvest yield are given in Table 20. The relative values are expressed versus the untreated soybean A, or relative to the same fungicide treatment but without phytosterol B.

TABLE 20
Harvest yield. Form. stands for Formulation of phytosterols.

| | | | | % vs. | % vs. without |
|---|---|---|---|---|---|
| Exp. | Treatment | kg/ha | | untreated A | phytosterols B |
| A | Untreated | 4354 | c | | |
| B | Fluxapyroxad/ | 5440 | ab | +24.9% | |
| | prothioconazole | | | | |
| C | Form. 1 + | 5686 | a | +30.6% | +4.5% |
| | Fluxapyroxad/ | | | | |
| | prothioconazole | | | | |
| D | Form. 2 + | 5684 | a | +30.5% | +4.5% |
| | Fluxapyroxad/ | | | | |
| | prothioconazole | | | | |
| E | Form. 3 + | 5597 | a | +28.5% | +2.9% |
| | Fluxapyroxad/ | | | | |
| | prothioconazole | | | | |

The results are as follows:
Untreated experiment A led to a strong reduction of harvest yield due to the impact of the above-mentioned fungal diseases.
A side-by-side comparison between an organo-chemical fungicide treatment B and the same fungicide treatment but combined with phytosterols (C, D or E) led to an increase in the harvest yield in the favor of the combination fungicide +phytosterols, with an increase in the range 2.9-4.5%.
Formulations 1 and 2 performed better than formulation 3 to further improve the harvest yield.

### 5. Agricultural Mixtures With Commercial Organo-Chemical Fungicides. Increase of Harvest Yield and Reduction of Diseases

The objective of the trial is to demonstrate the benefit to combine an organo-chemical fungicide treatment with two applications of a phytosterol composition comprising at least one phytosterol and at least one sucrose fatty acid ester, wherein both harvest yield and reduction of diseases are improved.

a. Materials and Methods

The experiments were conducted with formulation 2 of example 1, which was combined with a standard organo-chemical fungicide treatment.

Table 21 summarizes the two experiments. The products were applied at two different phenological stages.

TABLE 21
Experiments conducted in this example.

| | | | | | Total |
|---|---|---|---|---|---|
| | | | | | phytosterols |
| Exp. | R1 | R3 | R5.1 | R5.4 | (g/ha) |
| A | Mefentrifluconazole + | Benzovindiflupyr + | Inpyrfluxam + | Difenoconazole + | — |
| | Pyraclostrobin + | Prothioconazole | Prothioconazole | Cyproconazole | |
| | Fluxapyroxad | Mancozeb | Mancozeb | | |
| | Mancozeb | | | | |
| B | Mefentrifluconazole + | Benzovindiflupyr + | Inpyrfluxam + | Difenoconazole + | 50 |
| | Pyraclostrobin + | Prothioconazole | Prothioconazole | Cyproconazole | |
| | Fluxapyroxad | Mancozeb | Mancozeb | | |
| | Mancozeb | Formulation 2 | | | |
| | Formulation 2 | | | | |

Mefentrifluconazole + Pyraclostrobin + Fluxapyroxad is Belyan ® at 0.6 L/ha. Benzovindiflupyr + Prothioconazole is Mitrion ® at 0.45 L/ha. Inpyrfluxam + Prothioconazole is Fox ® Supra at 0.35 L/ha. Difenoconazole + Cyproconazole is Cypress ® at 0.3 L/ha. Mancozeb ® is at 1.5 L/ha.

Comparative experiment A corresponds to soybean treated with a standard organo-fungicide treatment, meaning without phytosterols. Experiment B combines this standard organo-fungicide treatment with two applications of formulation 2 at 25 g/ha of phytosterols, giving a total of 50 g/ha. Especially, SDHI molecules were tank-mixed to the phytosterol composition, namely benzovindiflupyr and fluxapyroxad.

b. Description of the Experimental Plot

The description of the experimental plot is presented in Table 22.

TABLE 22
Experimental plot.

| Crop (variety) | Soybean (Olimpro IPRO) |
|---|---|
| Sowing density | 220,000 plants/ha |
| Experimental setup | Microplots (15 m²) |
| Harvest (days after sowing) | 122 |
| Rainfalls (mm) | 810 |

c. Results

The protection efficiency of each experiment was estimated by calculating the area under the disease progress curve (AUDPC), and estimating the efficiency of the protection (ΣAUDPC) of a treated experiment against the untreated experiment (exp. A). From the results, a Tukey test with p≤0.05 was performed.

i. Corynespora cassiicola (Target Spot)

The results are given in Table 23.

TABLE 23
Control of Corynespora cassiicola

| Experiment | AUDPC | | ΣAUDPC (%) |
|---|---|---|---|
| A | 315.5 | a | 0 |
| B | 196.75 | b | 40.20 |

The results show that target spot disease was efficiently reduced by combining phytosterols with fungicides as in experiment B.

ii. Cercospora spp.

The results are given in Table 24.

TABLE 24
Control of Cercospora spp.

| | | | ΣAUDPC |
|---|---|---|---|
| Experiment | AUDPC | | (%) |
| A | 264.00 | a | 0 |
| B | 241.63 | a | 16.67 |

Although not statistically different, experiment B provided a better control of Cercospora spp. than experiment A.

iii. End of Cycle Diseases

The results are given in Table 25.

TABLE 25
Control of end of cycle diseases

| | | | ΣAUDPC |
|---|---|---|---|
| Experiment | AUDPC | | (%) |
| A | 512.75 | a | 0 |
| B | 326.50 | b | 24.82 |

The results show that end of cycle diseases were efficiently reduced by combining phytosterols with fungicides as in experiment B.

d. Harvest Yield

Harvest yield values are given in Table 26.

TABLE 26
Harvest yield

| | Yield | | |
|---|---|---|---|
| Experiment | (kg/ha) | | % vs. A |
| A | 3199.8 | a | |
| B | 3932.4 | b | +22.9% |

The results show a strong increase in the harvest yield when a phytosterol composition is combined with organo-chemical fungicide.

### 6. Increase of Harvest Yield and Decrease of Fungal Pressure With a Combination of a Phytosterol Composition and an Organo-Chemical Fungicide

The following Table summarizes multiple trials conducted with formulation 2 of example 1 (suspo-emulsion), wherein the phytosterol formulation was combined with an organo-chemical fungicide at R1 and R3 reproductive stages of soybean. Both harvest yield and disease protection were increased by combining the fungicide formulation and the phytosterol formulation.

TABLE 27
Performances of an organo-chemical fungicide-only treatment
vs. the same treatment but combined with a phytosterol formulation.
n is the number of trials used in this summary.

| | Fungicide | Fungicide and formulation | |
|---|---|---|---|
| | treatment | 2 at R1 and at R3 | |
| Harvest yield (kg/ha) n = 22 | 4356 | 4536 | (+4.1%) |

Reduction of diseases pressure (AUCPD)

| | | | |
|---|---|---|---|
| Corynespora cassiicola n = 7 | 320 | 237.8 | (−26%) |
| Erysiphe diffusa n = 2 | 18.9 | 10.2 | (−46%) |
| Phakopsora pachyrhizi n = 2 | 116.1 | 87.0 | (−25%) |
| Cercospora spp. n = 5 | 335.5 | 289.8 | (−14%) |
| Septoria glycines n = 5 | 393.7 | 244.5 | (−38%) |

1. A method of cultivating soybean exposed to at least one fungal disease comprising a step of applying to said cultivated soybean a combination comprising:
(i) an effective amount of at least one fungicide composition comprising at least one organo-chemical fungicide, and
(ii) an effective amount of at least one phytosterol composition comprising at least one phytosterol and at least one sucrose fatty acid ester, wherein at least two applications of said at least one phytosterol composition are combined with at least two applications of said at least one fungicide composition,
wherein at least one organo-chemical fungicide comprises an effective amount of fluxapyroxad.

2. The method of claim 1, wherein the treatment with said combination:
(i) increases the yield of said cultivated soybean in comparison to soybeans under similar conditions but treated only with the organo-chemical fungicide, and/or
(ii) reduces the effects of said at least one fungal disease on said field of cultivated soybean in comparison to soybeans under similar conditions but treated only with the organo-chemical fungicide treatment.

3. The method of claim 1, wherein the treatment with said combination:
(iii) sustains the yield of said cultivated soybean in comparison to soybeans under similar conditions but treated with a reduced dose of the fungicide composition comprising at least one organo-chemical fungicide, wherein the organo-chemical dose reduction is at least 10%.

4. The method of claim 1, wherein it comprises at least two applications of at least one organo-chemical fungicide, one application only being an organo-chemical fungicide comprising fluxapyroxad.

5. The method of claim 4, wherein the organo-chemical fungicide comprises an effective amount of fluxapyroxad and the at least one phytosterol composition are applied concomitantly.

6. The method of claim 5, wherein at least one phytosterol composition is applied prior to the application of the organo-chemical fungicide comprising an effective amount of fluxapyroxad and at least one phytosterol composition.

7. The method of claim 6, wherein both phytosterol composition are identical and/or wherein the phytosterol composition and the organo-chemical fungicide are applied between physiological stage V5 to R5.5 of the cultivated soybeans.

8. The method of claim 4, wherein the organo-chemical fungicide comprising an effective amount of Fluxapyroxad and the at least one phytosterol composition are applied separately.

9. The method of claim 8, wherein the organo-chemical fungicide comprising an effective amount of Fluxapyroxad is applied between two applications of the at least one phytosterol composition.

10. The method of claim 9, wherein phytosterol compositions are identical and/or wherein the phytosterol composition and the organo-chemical fungicide are applied between physiological stage V5 to R5.5 of the cultivated soybeans.

11. The method of claim 1, wherein it comprises at least two applications of at least one organo-chemical fungicide, said at least one organo-chemical fungicide comprising an effective amount of Fluxapyroxad.

12. The method of claim 11, wherein the organo-chemical fungicide comprises an effective amount of Fluxapyroxad and the at least one phytosterol composition are applied concomitantly, and/or wherein the phytosterol compositions of the at least two applications are identical.

13. The method of claim 1, wherein the organo-chemical fungicide comprises an effective amount of Fluxapyroxad and further comprises an effective amount of at least one strobilurin fungicide.

14. The method of claim 1, wherein the organo-chemical fungicide comprises an effective amount of Fluxapyroxad and further comprises an effective amount of at least one conazole or triazole fungicide.

15. The method of claim 1, wherein said at least one fungal disease is selected from the group consisting of Asian soybean rust; anthracnose; end-of-cycle diseases, advantageously purple seed stain and brown spot; target spot; powdery mildew; cercospora leaf blight; New World soybean rust; and combinations thereof.

16. The method of claim 15, wherein said at least one fungal disease is Asian soybean rust.

17. A composition comprising:
(i) an effective amount of Fluxapyroxad, and
(ii) an effective amount of at least one phytosterol composition comprising at least one phytosterol and at least one sucrose fatty acid ester.

18. The composition of claim 17, wherein the organo-chemical fungicide further comprises an effective amount of at least one strobilurin fungicide.

19. The composition of claim 17, wherein the organo-chemical fungicide further comprises an effective amount of at least one conazole fungicide.

20. A kit comprising:
(i) Fluxapyroxad, and
(ii) a phytosterol composition comprising at least one phytosterol and at least one sucrose fatty acid ester.

21. The kit of claim 20, wherein it further comprises at least one strobilurin fungicide.

22. The kit of claim 20, wherein it further comprises at least one conazole fungicide.

23. A slurry resulting from the dilution of a composition comprising (i) an effective amount of Fluxapyroxad, and (ii) an effective amount of at least one phytosterol composition comprising at least one phytosterol and at least one sucrose fatty acid ester.

24. The method of claim 1, wherein said at least one phytosterol is selected from the group consisting of: beta-sitosterol, campesterol, brassicasterol, stigmasterol, lanosterol, stigmastanol, campestanol, cycloartenol, gamma-sitosterol, Δ5-avenasterol, Δ7-avenasterol, isofucosterol, 5-dehydroepisterol, chlerosterol, sitostanol, stigmastadioenol, cholesterol, cholestanol, dinosterol, ergosterol, obtusifoliol, and mixtures thereof; or wherein said at least one phytosterol is a mixture of phytosterols containing β-sitosterol, which represents at least 30% of the phytosterols mixture by weight, with the balance to 100% containing, campesterol, stigmasterol, cholesterol and brassicasterol; and wherein said at least one sucrose fatty acid ester is selected from the group consisting of: sucrose stearate, sucrose palmitate, their polyesters and combinations thereof.

25. The method of claim 1, wherein:
said at least one phytosterol represents between 0.2% and 10% of the phytosterol composition by weight; and
said at least one sucrose fatty acid ester represents between 0.2% and 10% of the phytosterol composition by weight.

26. The method of claim 1, wherein the total concentration of said at least one phytosterol applied on cultivated soybean is between 2.5 g/ha to 250 g/ha, between 12.5 and 125 g/ha, or between 25 g/ha and 100 g/ha.

27. The composition of claim 17, wherein said at least one phytosterol is selected from the group consisting of: beta-sitosterol, campesterol, brassicasterol, stigmasterol, lanosterol, stigmastanol, campestanol, cycloartenol, gamma-sitosterol, Δ5-avenasterol, 47-avenasterol, isofucosterol, 5-dehydroepisterol, chlerosterol, sitostanol, stigmastadioenol, cholesterol, cholestanol, dinosterol, ergosterol, obtusifoliol, and mixtures thereof; or wherein said at least one phytosterol is a mixture of phytosterols containing B-sitosterol, which represents at least 30% of the phytosterols mixture by weight, with the balance to 100% containing, where appropriate, campesterol, stigmasterol, cholesterol and brassicasterol; and wherein said at least one sucrose fatty acid ester is selected from the group consisting of: sucrose stearate, sucrose palmitate, their polyesters and mixture thereof.

28. The composition of claim 17, wherein:
said at least one phytosterol represents between 0.2% and 10% of the phytosterol composition by weight; and
said at least one sucrose fatty acid ester represents between 0.2% and 10% of the phytosterol composition by weight.

29. The kit of claim 20, wherein said at least one phytosterol is selected from the group consisting of: beta-sitosterol, campesterol, brassicasterol, stigmasterol, lanosterol, stigmastanol, campestanol, cycloartenol, gamma-sitosterol, Δ5-avenasterol, Δ7-avenasterol, isofucosterol, 5-dehydroepisterol, chlerosterol, sitostanol, stigmastadioenol, cholesterol, cholestanol, dinosterol, ergosterol, obtusifoliol, and mixtures thereof; or wherein said at least one phytosterol is a mixture of phytosterols containing β-sitosterol, which represents at least 30% of the phytosterols mixture by weight, with the balance to 100% containing, where appropriate, campesterol, stigmasterol, cholesterol and brassicasterol; and wherein said at least one sucrose fatty acid ester is selected from the group consisting of: sucrose stearate, sucrose palmitate, their polyesters and mixture thereof.

30. The kit of claim 20, wherein:
said at least one phytosterol represents between 0.2% and 10% of the phytosterol composition by weight; and
said at least one sucrose fatty acid ester represents between 0.2% and 10% of the phytosterol composition by weight.
